(19) United States
(12) Patent Application Publication
(10) Pub. No.: US 2012/0091955 A1
(43) Pub. Date: Apr. 19, 2012

(54) Electric Vehicle Battery Recharge-Replacement System

(76) Inventor: Frank Fang Gao, (US)

(21) Appl. No.: 13/241,179

(22) Filed: Sep. 22, 2011

Related U.S. Application Data
(60) Provisional application No. 61/392,930, filed on Oct. 13, 2010.

(51) Int. Cl. H02J 7/00

(52) U.S. Cl. 320/109

(57) ABSTRACT

An electric vehicle battery recharge-replacement system has four major parts: (1) a rechargeable battery pack consisting of a number of separate sub-packs with an identical dimension and energy capacity, (2) a same number of battery sub-pack compartments on an electric vehicle, and all sub-pack compartments having an identical dimension, (3) a recharging array consisting of a number of individual recharging compartments stacking together, and each recharging compartment having a dimension same as the vehicle sub-pack compartment, and (4) some battery sub-pack holding cases, each of which having an identical dimension. With this system, battery pack replacement can be realized by replacing drained battery sub-packs in an electric vehicle's compartments with recharged battery sub-packs in a recharging array's compartments. In this system, each battery sup-pack can further consist of two to four identical sub-sub-packs, which are even lighter and easier to handle.

### CROSS-REFERENCE TO RELATED APPLICATION

This application claims priority from U.S. Provisional Application Ser. No. 61/392,930 filed on Oct. 13, 2010, and the contents of which are incorporated herein by reference in its entirety.

### STATEMENT REGARDING FEDERALLY SPONSORED RESEARCH OR DEVELOPMENT

Not applicable.

### FIELD OF THE INVENTION

The present invention, in general, relates to electric vehicles, and more specifically, to a recharge-replacement system that realizes practical replacement of drained batteries on electric vehicles with recharged batteries at recharge-replacement stations.

### BACKGROUND OF THE INVENTION

Electric vehicles are drawing more and more attention from automobile manufacturers, the public and governments of many countries due to their low energy cost and low-to-zero direct or indirect emissions of various air pollutants.

Advances in battery technology in recent years have significantly promoted development of electric vehicles. For example, a well-designed lithium-ion (Li-ion) battery pack has the capacity to power an electric vehicle (EV) for a 40-mile range, which covers about 80 percent of daily driving activities. A few automobile manufacturers have announced that they have planned to start mass production of EVs in early 2010s. Since the batteries are the only power source of electric vehicles, recharging drained batteries will become a routine task for EV drivers. It is generally anticipated that charging a battery on an electric vehicle may not be a problem for those vehicles that are parked in or beside residential parking garages since power outlets are readily accessible, even though running electric cables in a crowded garage may be a hassle if recharging work is performed on a daily basis.

For those drivers who do not have an easy or convenient access to power outlets, there is a practical problem for them to charge their EV batteries. This is particularly true in urban areas where residents usually have to park their vehicles in open spaces along street curbs and in public-owned parking lots. Charging electric vehicles at those open spaces may have practical problems. For example, those open spaces may not be close enough to a resident dwelling, and leaving an electric vehicle at charging status without close attention may not safe and secure. Some EV manufacturers, battery-charging equipment suppliers, hotel and supermarket owners have been discussing options of setting up charging stations at the parking lots of urban hotels or supermarkets. However, not many people live near hotels and supermarkets. In addition, leaving their electric vehicles at charging stations away from their residences for an extended period of time may not be liked by EV drivers. Therefore, the challenge or the difficulty in recharging EV batteries may hinder wide sales of electric vehicles, in particular, in urban areas.

Another potential solution for EV battery recharging problem is to build battery recharge-replacement stations, at which an EV driver can simply exchange his/her drained battery for a fully-charged battery which has been recharged at the station. This solution, if practical, would enable an EV driver to replenish his/her EV's power capacity fast, as fast as refilling a gasoline tank on a regular gasoline-powered vehicle. If an extensive network or infrastructure of such replacement stations could be built up, it could fully meet the recharging need of electric vehicles after mass production. However, some challenges exist. First, an EV battery, or more precisely an EV battery pack, usually has a relatively large volume and a heavy weight in order to hold a sufficient power capacity. Recent demonstrative replacement stations indicate that such stations need heavy equipment in structured facilities to perform battery pack replacement. Again, space availability remains a practical problem in urban areas. Secondly, construction of necessary facilities in replacement stations and installation of heavy equipment will need significant capital investments. Without heavy equipment and structured facilities, how to perform a quick replacement operation for the heavy battery packs will be a major challenge for either EV drivers or replacement stations.

It is obvious that there exists an urgent need in the current art for a convenient and effective method for recharging and/or replacing EV batteries in the upcoming build-up of EV battery recharging infrastructure.

### SUMMARY OF THE INVENTION AND ADVANTAGES

The present invention aims at providing a practical system that enables electric vehicle (EV) drivers to obtain recharged batteries for their EVs whenever needed. In particular, the present invention provides a special method to dismember an EV battery pack into uniform sub-packs, creates uniform battery sub-pack holding cases for both EVs and recharging arrays, thus making replacement operation of EV battery sub-packs practically doable at recharge-replacement stations by either EV drivers or station staffs without help of heavy equipment. The entire system of the present invention is easy to implement, and is expected to effectively facilitate an extensive EV recharge-replacement network or infrastructure that is critically needed along with EV mass production.

The present invention involves four major parts: (1) a number of individual battery sub-packs, each of which has an identical dimension and energy capacity, and the total capacity of all battery sub-packs can run an electric vehicle for a desirable driving range, (2) a same number of battery sub-pack compartments on an electric vehicle (hereafter referred to as sub-pack compartments), and all sub-pack compartments have an identical dimension, (3) a recharging array consisting of a number of individual recharging compartments, each of which has a dimension same as the vehicle sub-pack compartment, and (4) some battery sub-pack holding cases, each of which having an identical dimension. The number of battery sub-packs depends on battery design capacity and driving range of the EV. For example, based on the current Li-ion battery technologies and a 40-mile driving range originally powered by a 375-lb battery pack, five sub-packs can be designed and each sub-pack can be manufactured with a driving range of 8-mile and a weight about 75 pounds so that it can be moved manually by a strong adult. To further reduce the weight of each sub-pack, six battery sub-packs can be designed and used, and each sub-pack will have a weight about 60 pounds. In addition, each battery sup-pack can be manufactured by grouping together two to four identical sub-sub-packs (hereafter simplified as “ss-pack”). Each individual ss-pack will have a weight about ½ to ¼ of the sub-pack so that it can be handled by an adult more easily. It is anticipated that, with technology development of rechargeable batteries, the capacity and driving range of each sub-pack or ss-pack will increase, or the weight of those sub-pack or ss-pack will decrease. The following description of the present invention uses five battery sub-packs for demonstration and simplification purpose.

The locations of five sub-pack compartments may vary, depending on EV models, available spaces on an EV and degree of easy access to those spaces. A preferred embodiment is to locate the first four vehicle compartments under driver's seat, left rear seat, passenger's seat, and right rear seat, respectively. Usually, there is a potential space of approximately 25×15×10-inch³ under each of the above seats of an electric vehicle. Therefore, as long the battery sub-pack holding case (see next paragraph) is smaller than this potential space but large enough to accommodate a battery sub-pack, this potential space can be explored for a solid and strong battery sub-pack compartment. The compartments at those locations are easy to access, and well protected from theft and rainfall because they can be covered and locked instantaneously when the vehicle doors are closed and locked. Another sub-pack compartment (i.e., the fifth compartment) can be located in the rear truck. This location is also safe from theft and rain since it is covered and locked when the trunk is locked. Within each vehicle sub-pack compartment, a sub-pack holding case (hereafter referred to as vehicle battery sub-pack holding case or simply as sub-pack holding case) is installed on a pair of sliding rulers so that the sub-pack case can slide easily into and out from the compartment sideways.

For a recharging array, several recharging compartments can be stacked together or in a matrix form. Within each recharging compartment of the recharging array, a sub-pack recharging case (or simply referred to as recharging case) with a dimension same as the vehicle sub-pack holding case is installed on a pair of sliding rulers so that the recharging case can slide into and out from the recharging compartment easily and quickly.

An EV battery sub-pack can be installed in the sub-pack holding case or the sub-pack recharging case with necessary fastening devices and functional connections in either a sub-pack compartment on an EV or a recharging compartment of a recharging array. With such an arrangement, the heavy battery pack is dismembered and handled as five separate individual sub-packs, each of which can be further handled by handling two or four much lighter ss-packs individually.

Power delivery from individual sub-packs on an EV is operated automatically or manually through an on-vehicle sub-pack control panel that is located in a convenient location for the EV driver. The control panel also displays capacity status of each sub-pack. For a recharging array, sub-pack recharging is managed automatically or manually through the array's control panel, which is located on a convenient location on the recharging stack or matrix.

For one recharge-replacement station, one or several recharging arrays may be deployed, depending on demands on EV battery recharging in the surrounding areas. It will be desirable to build a recharge-replacement station at an existing gasoline station and to deploy a recharging array or arrays in locations convenient for EV drivers. Such arrangements will save land, reduce capital investments, promote effective management and lower maintenance cost, thus leading to lower battery charging fees.

When an electric vehicle runs, the driver decides, according to sub-pack capacity information being updated continuously and displayed on the sub-pack control panel, when to replace the battery sub-packs. When a replacement decision is made, the driver drives the EV into the nearest recharge-replacement station, stops the vehicle by a recharging array, opens a vehicle sub-pack compartment, pulls the sub-pack holding case with the drained sub-pack out from the sub-pack compartment, disengages all fastening devices and functional connections, and then removes the drained sub-pack from the holding case. The empty sub-pack holding case is now ready for a newly-charged sub-pack. The driver uses the same procedure to obtain a fully-charged sub-pack from one recharging compartment in the recharging array. The driver then installs the new sub-pack into the EV sub-pack holding case, engages all fastening devices and functional connections, pushes the holding case into the sub-pack compartment and closes the compartment door. The driver uses the same procedure to install the drained sub-pack pack into the recharging case and pushes the recharging case back into the recharging compartment. Recharging of the drained sub-pack in the recharging compartment can be then started either automatically or manually, or by a pre-set schedule for off-peak charging. The EV driver then follows the same steps to replace other drained sub-packs on the EV.

The present invention converts handling of a heavy battery pack into handling individual sub-packs. By dismembering a single, bulky and heavy battery pack into five separate sub-packs, each of which may be further dismembered into two to four individual ss-packs, the only weight-lifting task in replacement operation is unloading or loading the much lighter sub-packs or ss-packs from or into EV's sub-pack holding cases or the recharging array's recharging cases. Transporting of the battery sub-pack between the EV and the recharging array can be performed with the help of a wheeled cart. It is further preferred that the replacement process be managed by a station staff member, with a reasonable service fee to be added to the sub-pack recharge-replacement fee. A serviced replacement is likely to shorten the replacement process, to avoid some operational errors, and to be even necessary sometimes for some physically-weak drivers.

The advantages of the present invention are obvious. First, the much smaller battery sub-packs (or ss-packs) are much easier to manufacture, transport and install. The dismemberment of a huge battery pack into several sub-packs provides EV manufacturers flexibility in locating the battery sub-packs in the EV bodies.

Secondly, the present invention makes it possible to standardize battery sub-packs for universal use on many, if not all, models of passenger EVs. Small compact EVs can use three to four standardized battery sub-packs, while medium or luxurious sedans can use five to six standardized battery sub-packs. In practice, it may need to make two types of standardized battery sub-packs, one smaller type and one bigger type. The smaller type is for small EVs since their bodies are small, and the bigger type is for bigger EVs since their bodies are bigger. It can be expected that when one type, or two types, of standardized battery sub-packs can be used by many EV manufacturers, the economy of scale will function significantly in battery manufacturing, thus reducing the cost of battery sub-packs significantly. In addition, standardization of battery sub-packs will enable battery recharge-replacement stations to charge and store only one or two types of sub-packs, solving a critical problem of battery replacement practice.

Thirdly, the uniform dimension of the battery sub-pack cases for both EV's sub-pack compartment and recharging array's recharging compartment makes it practically feasible to exchange drained and recharged batteries at a recharge-replacement station. More specifically, the uniform sub-pack cases and associated sliding mechanism make it much easier for either EV drivers or station staffs to remove or install a battery sub-pack from or into both electric vehicles and recharging arrays at a recharge-replacement station.

Further, the EV owners will no longer need to charge their EV batteries at home, or at charging stations away from homes, nor will they need to wait for extended period of time for recharging drained battery packs. To be free from the recharging burden is extremely important for urban residents, and will promote a wide acceptance and usage of electric vehicles, and therefore promoting energy conservation and environmental protection.

Further, the recharging array can be conveniently installed at many existing gasoline stations in parallel to gasoline dispensers. Therefore, additional land and space for battery recharge-replacement activities will be minimized. With such arrangement, an EV owner can replace the battery, and at the same time refill the gasoline tank when necessary if such a tank is installed for an electricity-generating engine on the vehicle. Considering the existence of vast infrastructures of gasoline stations throughout many countries, the present invention will help build up very quickly extensive and convenient networks of recharge-replacement stations in many countries.

Further, when an extensive infrastructure of recharge-replacement stations is established along with the existing gasoline station network, the EV's driving range can be designed mainly according to its daily routine needs, say a 40-50 mile range. Such a shorter running range will reduce capacity requirement on the battery pack, and will lead to reductions in size and weight of the battery pack, and thus of the battery sub-packs of the present invention. In return, installation of battery sub-pack compartments on EVs and recharging compartments in recharging arrays will become easier and more practical, which will promote EV productions and sales. It can be expected that with a growing usage of EVs, demands on gasoline will drop. Therefore, a foreseeable benefit from combing battery replacement stations with existing gasoline stations is to provide the gasoline stations an opportunity to expand a gasoline-only function gradually to a dual gasoline-plus-battery function. Such a co-existence of gasoline station and EV battery recharge-replacement station will extend the lifespan of many gasoline stations.

Further, with appropriate financial arrangements among relevant parties, including EV manufacturers/dealers, buyers, battery manufacturers, station owners/operators and financing institutions, electric vehicles can be sold with a deduction of battery cost, which will be paid off by EV owners when they pay recharge-replacement fees. In other words, instead of paying a significant total amount of money for the expensive rechargeable battery sub-packs, an EV buyer can divide the battery cost into insignificant fractions and pay it off over a long period of time of ownership of the EV. This arrangement will actually define the battery pack as a separate product from the purchased EV. With a continuous payment of the fractioned battery costs in recharge-replacement fees, an electric vehicle owner will no longer worry about battery life.

Finally, the present invention will enhance collaborations among automobile manufacturers, rechargeable battery manufacturers, and gasoline producers that currently operate gasoline stations. In addition, the present invention, if implemented, will stimulate R & D and manufacturing of instrumental devices for operational controls of the recharge-replacement system, such as the on-vehicle sub-pack control system and panels, and the recharging array control system and panels.

It should be pointed out that the battery sub-pack case of the present invention can be manufactured as a stand-alone recharging unit so that it can be used in other settings, such as residential garages or small business parking shops. Owning a group of stand-alone recharging units at home or by small business owners in their convenient format will allow many EV drivers to manage their EVs in a more flexible way, if they prefer.

### BRIEF DESCRIPTION OF THE DRAWINGS

FIG. 1 is a perspective diagram of an EV battery recharge-replacement system of the present invention.

FIG. 2 is a perspective diagram showing five locations of EV battery sub-pack compartments in a preferred embodiment of the present invention.

FIG. 3 is a perspective diagram showing structural components and their relative relations of a battery sub-pack, its holding case and the compartment accommodating the holding case.

FIG. 4 is a perspective diagram showing an EV battery sub-pack in its holding case in a sub-pack compartment under the driver's seat, and an on-vehicle sub-pack control panel.

FIG. 5 is a perspective diagram showing a preferred location of the fifth battery sub-pack compartment in the rear trunk of an EV.

FIG. 5a is a cross-section view of cross-section A-A as delineated in FIG. 5.

FIG. 6 is a perspective view of a recharging array of the present invention.

FIG. 7 is a perspective view of a multi-step supporting cart to support the holding cases and battery sub-packs of the recharging array of the present invention.

FIG. 7a is a diagram showing details of Section B as delineated in FIG. 7.

FIG. 8 is a perspective diagram showing how an EV battery sub-pack is dismembered into two to four sub-sub-packs (ss-packs) in the longitude direction (L-direction).

FIG. 9 is a perspective diagram showing how the ss-packs are connected to form and function as a sub-pack in L-direction.

FIG. 10 is a perspective diagram showing how an EV battery sub-pack is dismembered into two to four sub-sub-packs (ss-packs) in the latitude direction (W-direction).

FIG. 11 is a diagram showing how two adjacent ss-packs are connected to form and function as a sub-pack in W-direction.

### DETAILED DESCRIPTION OF THE PREFERRED EMBODIMENT

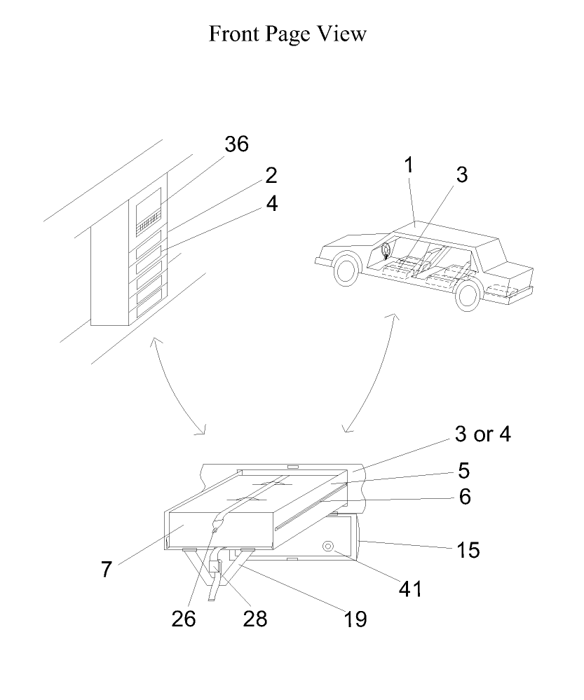

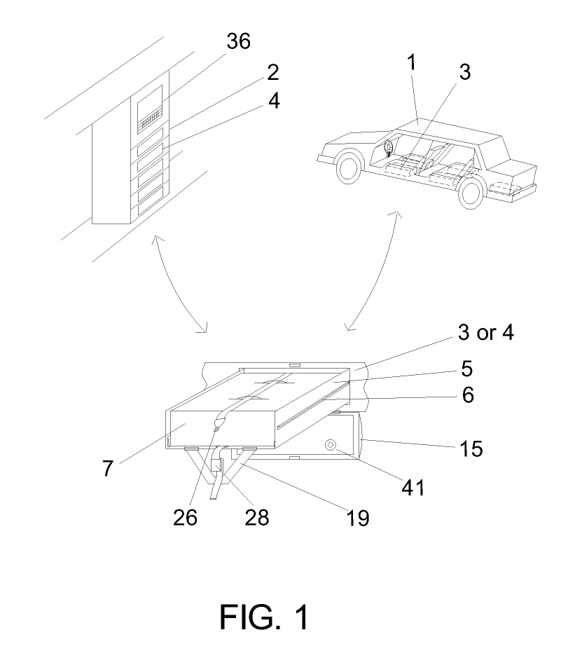

The description herein is presented progressively with FIG. 1 through FIG. 11, in which the same numerals indicate the same components.

FIG. 1 is a demonstration of a preferred embodiment of the present invention. In FIG. 1, an electric vehicle (EV) 1 is parked near a recharging array 2 in a recharge-replacement station. On said EV 1, there are a few battery sub-pack compartments 3. In said recharging array 2, there are a few recharging compartments 4. Each said sub-pack compartment 3 and said recharging compartment 4 has a sub-pack holding case 5 in it. Said holding case 5 is installed on a pair of sliding rulers 6, so that said holding case 5 can be pushed into or pulled out from the said compartment 3 or said compartment 4. The dimension of said holding case 5 is such that accommodates an EV battery sub-pack 7.

When said battery sub-pack 7 in said EV 1 is drained and needs to be replaced (this drained sub-pack is hereafter denoted as 7-d, where d represents “drained”), its holding case 5 is pulled out from said sub-pack compartment 3. Said battery sub-pack 7-d is unlocked and removed. Said sup-pack 7-d can be placed on a carrying cart for transporting to said recharging array 2 (the carrying cart is not a part of the present invention and thus not shown in FIG. 1). At said recharging array 2, a recharging compartment 4 is opened, and its sub-pack holding case 5 with a fully-charged battery sub-pack 7 (hereafter denoted as 7-c, where c represents “charged”) is pulled out. Said sub-pack 7-c is unlocked and removed to the carrying cart. Said sub-pack 7-d is placed in the recharging holding case 5, which is then reinstalled into said recharging compartment 4 for recharging. The said sub-pack 7-c is moved to said EV 1 and installed in the EV's holding case 5. Said holding case 5 is then reinstalled into said sub-pack compartment 3 of said EV 1. Other battery sub-packs on said EV 1 can be replaced with the same procedure. Said EV 1 is then ready for running on the newly installed sub-pack 7-c.

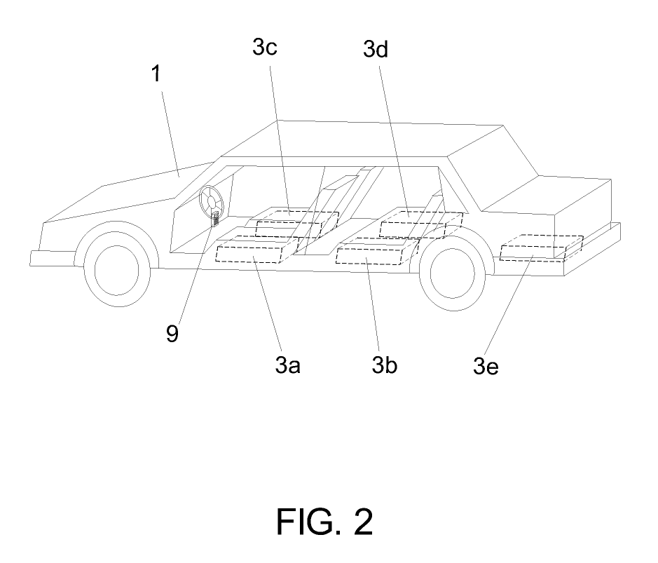

FIG. 2 shows the locations of five battery sub-pack compartments 3 on an EV 1 in a preferred embodiment of the present invention. The first four said compartments (labeled as 3a, 3b, 3c, and 3d, respectively) are under driver's seat, left rear seat, passenger's seat, and right rear seat, respectively. The fifth compartment 3e is in the rear trunk of said EV 1. A sub-pack holding case 5 is installed in each of said first four compartments with a pair of sliding rulers 6 (shown in FIG. 1). Said fifth compartment 3e does not have a pair of sliding rulers. Instead, a sub-pack holding case 5 is fixed in said compartment 3e. Also shown in FIG. 2 is a battery sub-pack control panel 9, which is used to exhibit capacity statuses of all battery sub-packs and to input driver's instructions for sub-pack operation.

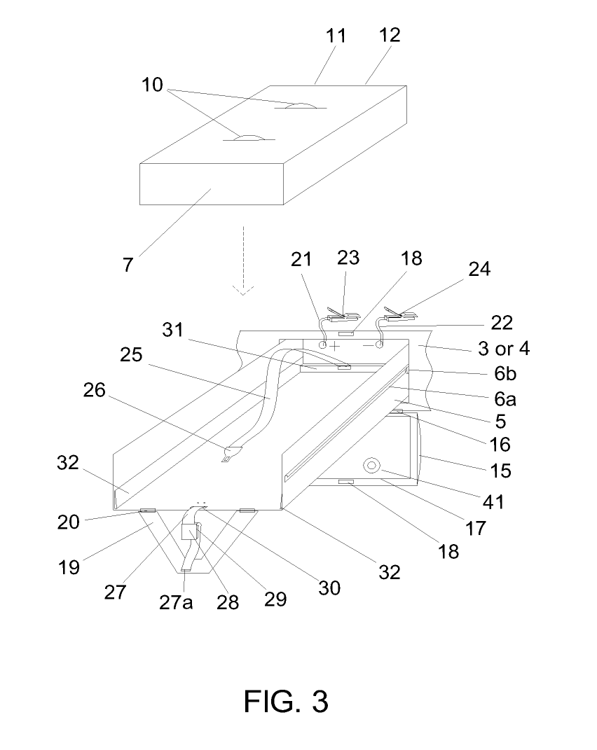

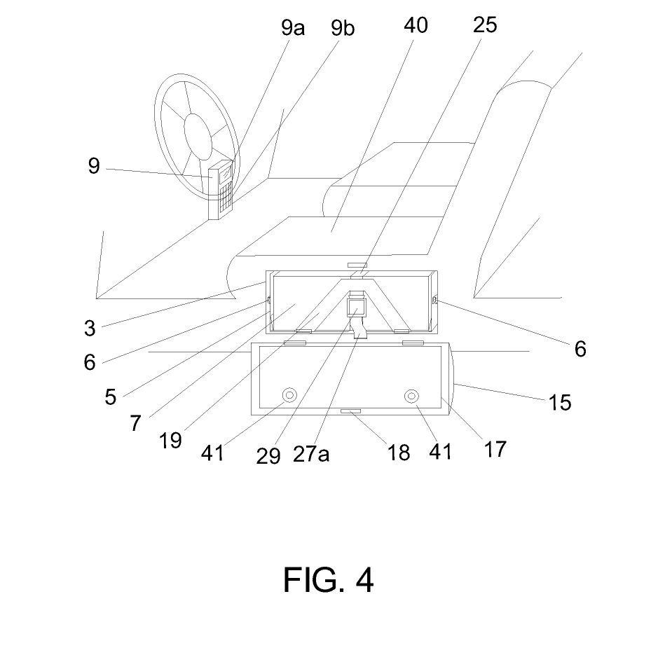

FIG. 3 shows the structural components of a sub-pack compartment 3 (3a, 3b, 3c, or 3d, but not 3e, in FIG. 2) on an EV 1, its holding case 5, and a sub-pack 7 ready for installation. In FIG. 3, said compartment 3 has a door 15 that is hinged with two fixed hinges 16 (only portion of one hinge is seen in FIG. 3) at the lower edge of the opening of said compartment 3. Along the inside perimeter of said door 15 runs a sealing strip 17, which is made of water-proof materials such as rubber. In addition, on the inner surface of said door 15 there are two pressing buttons 41 that can press on said sub-pack 7 inwardly when said door 15 is closed (in FIG. 3 only on pressing button is shown). Said door 15 opens and closes vertically, and when closed, stays closed with a push-in latch pair 18. Said door 15 swings vertically by 180 degrees on said hinges 16 for a full open and then hangs on said hinges 16. Said sub-pack holding case 5 has an open top and an open rear, and is installed within said compartment 3 on two sliding-ruler pairs 6a-6b (only one pair is seen in FIG. 4), whose two moving partners 6a are fixed on the outer surfaces of the holding case's left sidewall and right sidewall, respectively, and whose two unmoving partners 6b are fixed on the inner surfaces of said compartment's left sidewall and right sidewall, respectively. Said two sliding ruler pairs 6a-6b allow said case 5 to move into and out from said compartment 3 easily. At the rear edge of the solid bottom of said case 5, a V-shape supporting leg 19 is attached with two hinges 20, which allow said supporting leg 19 to swing vertically by 180 degrees. When in a downward position, one end of said supporting leg 19 touches the ground so that said supporting leg supports said case 5 when it is fully out from said compartment 3. The solid front sidewall of said holding case 5 has two holes, through which an anode cable 21 and a cathode cable 22 come out. Said anode cable 21 has an anode clamp 23 at its end. Said cathode cable 22 has a cathode clamp 24 at its end. The other ends of said anode cable 21 and said cathode cable 22 (not shown in FIG. 4) are to provide power to various functional units of said EV 1 when a battery sub-pack 7 is installed in said case 5.

Also shown in FIG. 3 are a fastening belt 25 with a tab (i.e., a male buckle) 26 attached at one end, and another fastening belt 27 with one end going through a female buckle 28 with a release lever 29. The other end of said belt 25 is fixed at the center top edge of a spacing block 31 at the front lower corner of said case 5. The other end of said belt 27 is fixed at the center of the rear edge of the solid bottom of said holding case 5. Said female buckle 28 allows said belts 25 and 27 to be tightened, by pulling the free end 27a of said belt 27, after said tab 26 is inserted in said female buckle 28. Said release lever 29 is used to release said tab 26. At the center of the rear edge of the solid bottom of said case 5, there is a rectangular notch 30 which allows said belt 27 to get through.

In FIG. 3 also, a battery sub-pack 7 is about to sit into said case 5. Said spacing block 31 is to position said sub-pack 7 and to allow a space between said sub-pack 7 and the solid front sidewall of said case 5 for said anode cable 21 and its clamp 23, and said cathode cable 22 and its clamp 24. The distance between the out-facing surface of said spacing block 31 and the front edge of said notch 30 is slightly smaller than the length of said sub-pack 7, so that said sub-pack 7 can tightly fastened when said belt 25 and said belt 27 are tightened. Each of the inside surface of the left sidewall and the inside surface of the right sidewall of said case 5 has a slanting slope 32 at its lower one-third portion. The distance between the foot-lines of two said slanting slopes 32 is equal to the width of said battery sub-pack 7, so that when said sub-pack 7 sits in said case 5, said sub-pack 7 will not move laterally.

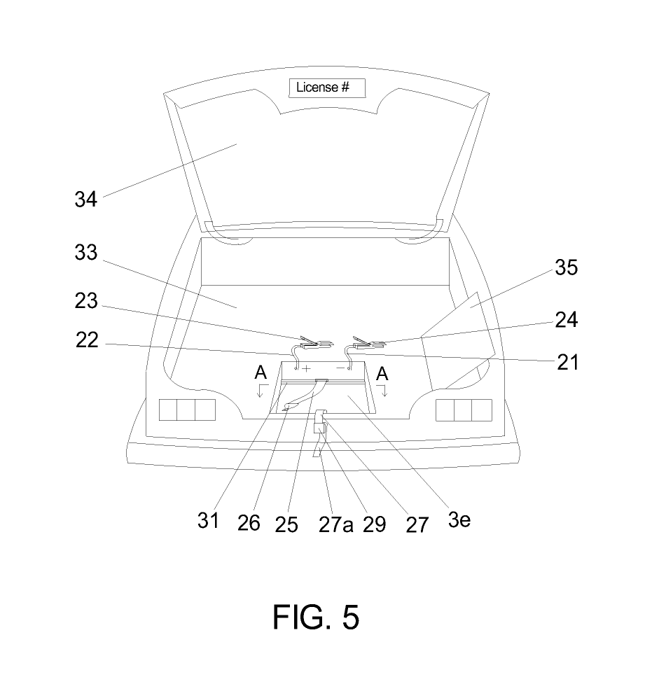

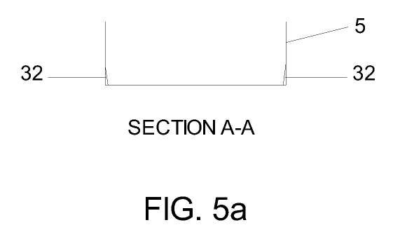

FIG. 4 is a demonstration that a battery sub-pack 7 is installed in a sub-pack compartment 3a under a driver's seat 40 of said EV 1. Note that the demonstration in FIG. 4 represents also sub-pack compartments 3b, 3c, or 3d, but not 3e, of said EV 1. For sub-pack compartment 3e, see demonstration in FIG. 5. Said sub-pack 7 and its holding case 5 are secured by a pair of tightened fastening belts 25 and 27. As shown in FIG. 4, said fastening belt 27, when tightened, goes through said rectangular notch 30. In FIG. 4, said supporting leg 19 is in its upward position, and said compartment door 15 is in a fully open position, showing said sealing strip 17 and said two pressing buttons 41. Also shown in FIG. 4 is a battery sub-pack control panel 9 at a convenient location close to the dashboard of said EV 1. Said sub-pack control panel 9 has a keypad 9a, a display screen 9b, a group of anode wires and a group of cathode wires (not seen in FIG. 4), with one of anode wires and one of cathode wires being connected to anode cable and cathode cable, respectively, of each sub-pack holding case 5. Said control panel 9 also contains a computerized program (not seen in FIG. 4) to manage power delivery from individual sub-packs among said sub-pack compartments 3a, 3b, 3c, 3d, and 3e.

FIG. 5 demonstrates a preferred location of the fifth sub-pack compartment 3e on said EV 1. Said compartment 3e is located in a rear portion in the EV's rear trunk 33 and is easily accessible when the trunk cover 34 is lifted. Being different from other sub-pack compartments 3a, 3b, 3c, and 3d, said compartment 3e has a sub-pack holding case 5 fixed at its location. Said compartment 3e and said holding case 5 have all components as described in FIG. 3, except two pairs of sliding rulers. In addition, said compartment 3e has a flat top-cover 35, instead of a compartment door. It should be noted that if a sixth battery sub-pack would be needed for more power and longer driving capability, another compartment could be easily installed side by side with said compartment 3e.

FIG. 5a is a cross-section view of cross-section A-A as indicated in FIG. 5, showing said slanting slope 32 of said holding case 5.

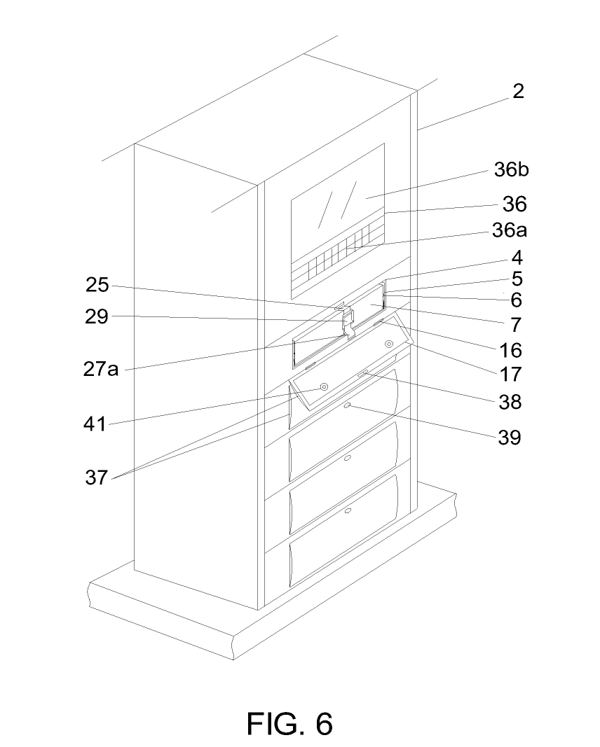

FIG. 6 demonstrates a recharging array 2, with a battery sub-pack 7 being installed in a recharging compartment 4 while other four recharging compartments are closed. Said sub-pack 7 and its holding case 5 are secured by a pair of tightened fastening belts 25 and 27. Said fastening belt 27, when tightened, goes through said rectangular notch 30. Also shown in FIG. 6 is a battery recharging control panel 36 at the top portion of said recharging array 2. Said recharging control panel 36 has a keypad 36a, a display screen 36b, a group of anode wires and a group of cathode wires (not shown in FIG. 6), with one of anode wires and one of cathode wires being connected to anode cable and cathode cable, respectively, of each sub-pack holding case. Said recharging control panel 36 also has a computerized controller (not seen in FIG. 6) to schedule and operate charging processes for individual sub-packs in said recharging array 2. Said recharging compartment 4 has a compartment door 37, which has a door lock 38 and a door knob 39. Said door lock 38 can be controlled either by a manual key or keying in a special code from said keypad 36a. Said door 37 is made with strong and rust-resistant material to endure continuous longtime exposure to the atmosphere. Similarly, along the inside perimeter of said door 37 runs a sealing strip 17, made of water-proof materials such as rubber. On the inner surface of said door 37, there are two pressing button 41, which will press said sub-pack inwardly when said door 37 is closed.

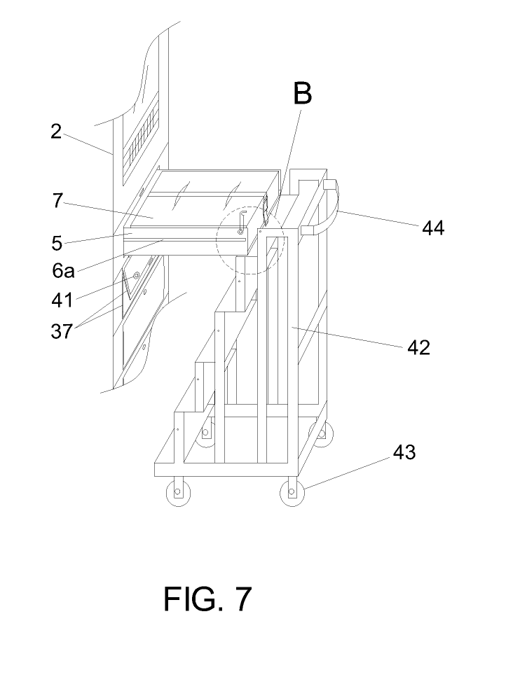

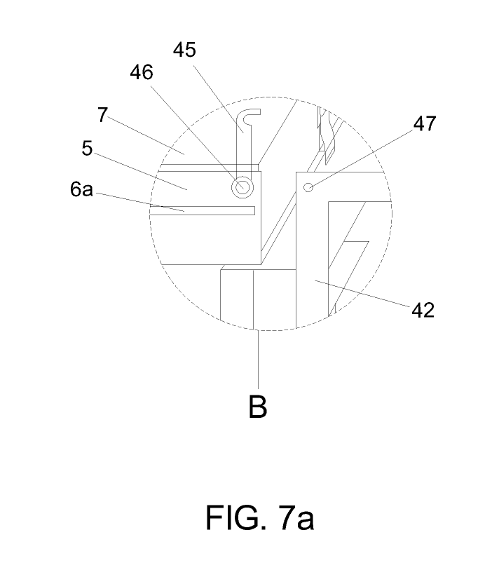

FIG. 7 demonstrates a multi-step supporting cart 42 of the present invention. Said supporting cart 42 has four all-way wheels 43, a handle 44, and multiple supporting steps (FIG. 7 shows a 5-step cart to match a 5-compartment recharging array as shown in FIG. 6). Each supporting step will support a corresponding recharging case 5 and a sub-pack 7 at the same height. FIG. 7a is a magnified form of Section B in FIG. 7, showing details of how said recharging case 5 is secured by a turning hook 45 and a hooking pin 47 on the corresponding supporting step. Said hook 45 is attached to the outer surface of the left sidewall of said recharging case 5 by a bolt 46. Said hook 45 can turn clockwise on said bolt 46 to hook with said hooking pin 47 so that said supporting cart 42 will stay with said recharging case 5 during loading and/or unloading operation of said sub-pack 7.

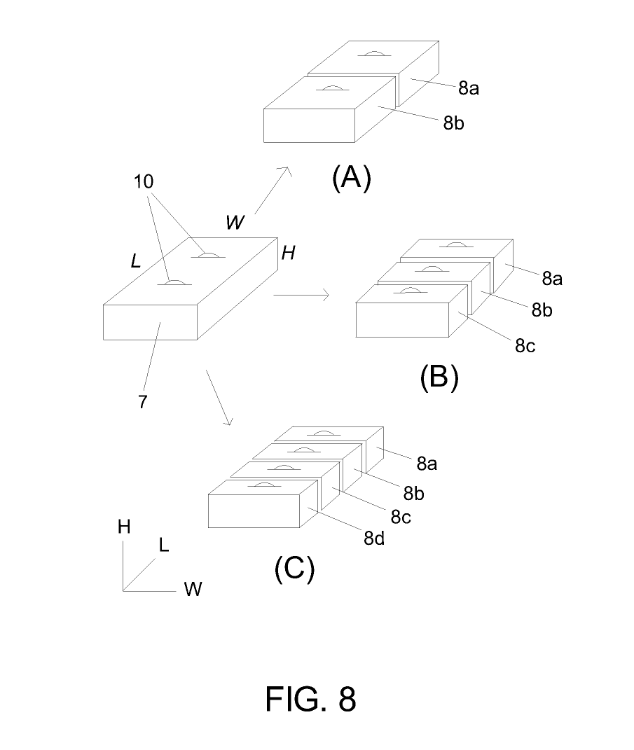

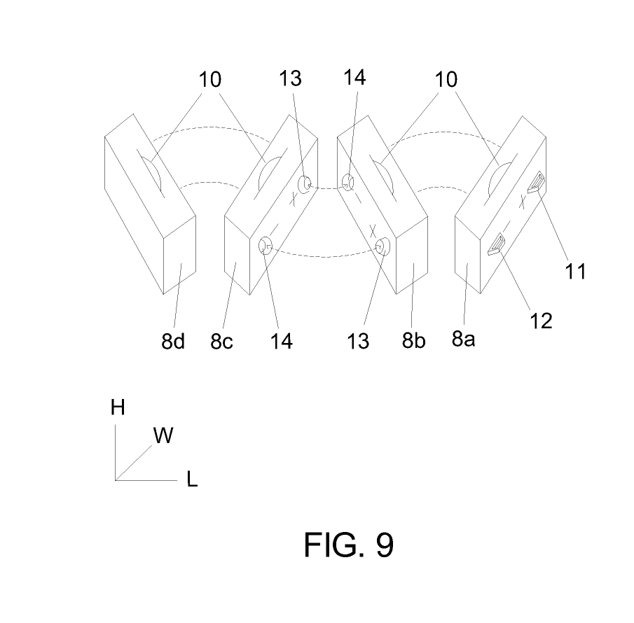

FIG. 8 shows how said battery sub-pack 7 could be further divided into two, three or even four sub-sub-packs (ss-pack), denoted as 8a, 8b, 8c, and 8e in the longitudinal direction (i.e., L-dimension in FIG. 8). FIG. 9 demonstrates the structure of each ss-pack and how those ss-packs connect to each other. Each ss-pack has a lifting handle 10 on its top surface for griping and lifting. The first said ss-pack 8a has an anode clamp-able connector 11 and a cathode clamp-able connector 12, which connect to an anode cable clamp 23 and a cathode cable clamp 24 (not shown in FIG. 9, but in FIG. 3), respectively, of said holding case 5 for power delivery (on an EV) or for recharging (in a recharging array). On the front surfaces of the second ss-pack 8b, third ss-pack 8c and fourth ss-packs 8d, there are a male anode connecter 13 and a female cathode connecter 14 (they are seen on the front surface of said third ss-pack 8c only in FIG. 9). On the rear surfaces of the first ss-pack 8a, second ss-pack 8b and third ss-pack 8c, there are a female cathode connector 14 and a male anode connector 13 (they are seen on the rear surface of said second ss-pack 8b only in FIG. 9). All ss-packs will align precisely for correct and tight connections between their male connectors 13 and the female connectors 14 of their neighboring ss-packs after they are positioned and tightened in said case 5 by said fastening belts 25 and 27.

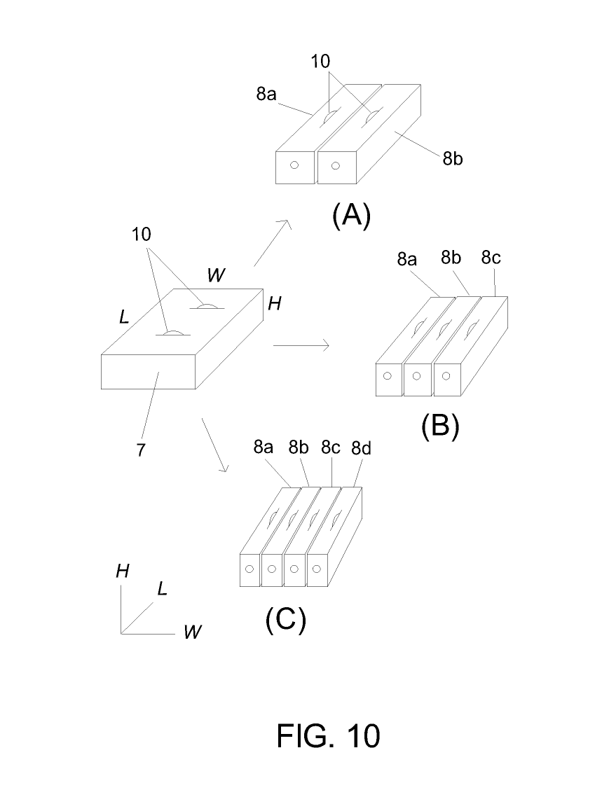

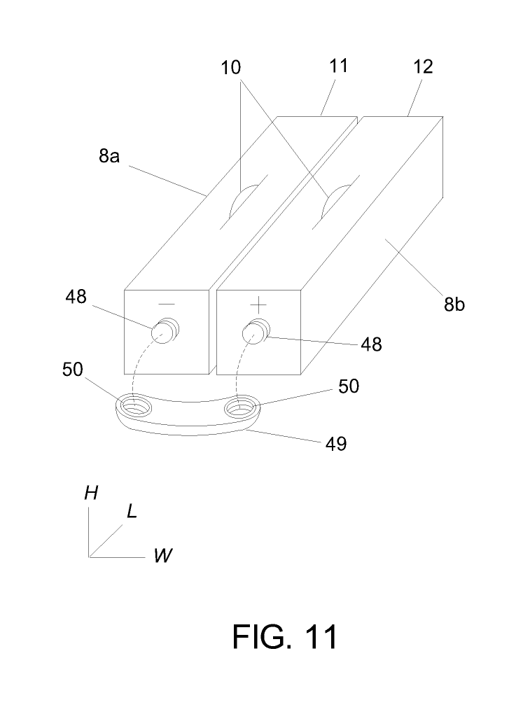

FIG. 10 shows how said battery sub-pack 7 could be further divided into two, three or even four sub-sub-packs (ss-pack), denoted as 8a, 8b, 8c, and 8e in the latitudinal direction (i.e., W-dimension in FIG. 10). FIG. 11 uses two latitudinal ss-packs to demonstrate the structure of each ss-pack and how those two adjacent ss-packs connect to each other. Each ss-pack has a lifting handle 10 on its top surface for griping and lifting. On their front end surfaces, the first said ss-pack 8a has an anode clamp-able connector 11, and the second said ss-pack 8b has a cathode clamp-able connector 12, which connect to an anode cable clamp 23 and a cathode cable clamp 24 (not shown in FIG. 11, but in FIG. 3), respectively, of said holding case 5 for power delivery (on an EV) or for recharging (in a recharging array). On their rear surfaces, both said ss-pack 8a and ss-pack 8b have a male snap-connecter 48. Two said male connecters are linked by a removable cable 49 which has one female connecter 50. Said female snap-connecter can snap tightly with said male snap-connecter 48, thus providing a secured connection between two adjacent ss-packs 8a and 8b.

What is claimed is:

1. An electric vehicle battery recharge-replacement system comprising
a rechargeable battery pack comprising two to six individual battery sub-packs, and each said sub-pack having an identical dimension and an identical power capacity;
a few sub-pack holding cases, each of which being able to accommodate one said battery sub-pack;
two to six vehicle battery sub-pack compartments, said sub-pack compartments each having an identical dimension and being able to accommodates one said sub-pack holding case;
a vehicle battery sub-pack control panel;
a recharging array comprising two to six recharging sub-pack compartments being stacked together, each of said recharging sub-pack compartments having a structural dimension same as said vehicle sub-pack compartment, and being able to accommodate one said sub-pack holding case;
a recharging array control panel; and
a supporting cart.

2. Each said battery sub-pack in claim 1 further comprising two to four sub-sub-packs, said sub-sub-packs being able to electrically connect in a head-to-end arrangement when being packed together either longitudinally or latitudinally to function as a said battery sub-pack, and being able to separate from each other when being unpacked, and when being packed longitudinally one said sub-sub-pack at its front end having a clamp-able anode connector and a clamp-able cathode connector; when being packed latitudinally one said sub-sub-pack at its front end having a clamp-able anode connector and another said sub-sub-pack at its front end having a clamp-able cathode connector.

3. Each said sub-pack holding case in claim 1 further comprising a solid bottom with a rectangular notch at center of its rear edge, a solid left sidewall, a solid right sidewall, a solid front sidewall, an open top, an open rear, a spacing block at front lower corner, one fastening belt with one end being fixed at center top edge of said spacing block and another end being attached with a tab, another fastening belt going through a releasable female buckle and with one end being fixed on said compartment bottom in front of said rectangular notch, one anode cable, and one cathode cable.

4. The said anode cable and cathode cable in claim 3 further comprising an anode clamp and a cathode clamp, respectively, and being able to clamp with said anode connector and cathode connector, respectively, in claim 2; said anode cable and cathode cable being electrically isolated and each going through a hole on said solid front sidewall of said holding case in claims 1 and 3.

5. Each of said vehicle sub-pack compartments in claim 1 further comprising
a solid structure being fixed inside vehicle body and said structure being able to accommodates a said sub-pack holding case in claims 1, 3 and 4;
a solid bottom, a solid front sidewall, a solid left sidewall, a solid right sidewall, an open top, a hinged rear-end door with an open-close latch on its edge opposite to its hinged edge, and a water-proof strip along perimeter on the inside surface of said rear-end door;
a pair of sliding rulers, whose two unmoving plates being fixed each on inside surface of said left sidewall and inside surface of said right sidewall, respectively, and whose two moving plates being fixed each on outside surface of said left sidewall and outside surface of said right sidewall of said sub-pack holding case in claims 1, 3 and 4, and providing sliding mechanism for said sub-pack holding case in claims 1, 3 and 4.

6. The said vehicle battery control panel in claim 1 comprising a keypad and a display screen at convenient location on or near an electric vehicle's dashboard, a group of anode wires, each connecting with a said anode cable of one said holding case in claims 1, 3 and 4, a group of cathode wires, each of them connecting with a said cathode cable of the same holding case, and a micro-processer programs to control functions of each said battery sub-pack in claims 1 and 2.

7. Each of said sub-pack recharging compartments of said recharging array in claim 1 further comprising
a solid structure being able to accommodates a said sub-pack holding case in claims 1, 3 and 4;
a solid bottom, a solid front sidewall, a solid left sidewall, and a solid right sidewall, a solid top, a hinged rear-end door with an open-close lock on its edge opposite to its hinged edge, and water-proof strip along perimeter on the inside surface of said rear-end door;
a pair of sliding rulers, whose two unmoving plates being fixed each on inside surface of said left sidewall and inside surface of said right sidewall, respectively, and whose two moving plates being fixed each on outside surface of said left sidewall and outside surface of said right sidewall of said sub-pack holding case in claims 1, 3 and 4, and providing sliding mechanism for said holding case in claims 1, 3 and 4.

8. The said recharging array control panel in claim 1 further comprising
a group of anode wires and a group of cathode wires, each wire in said anode group connecting to said anode clamp of one said sub-pack holding case in claims 1, 3 and 4 being placed in one said recharging compartment in claims 1 and 7, and each wire in said cathode group connecting to said cathode clamp of the same holding case being placed in the same recharging compartment;
a display screen at a convenient location on said recharging array in claim 1, whose function being to indicate remaining capacity, to schedule and control start-up and shut-off charging process for a said sub-pack in claims 1 and 2 being placed in said holding case in claims 1, 3 and 4 which being placed in said recharging compartment in claims 1 and 7, and to control said lock in claim 7;
a keypad for input of operational instructions.

9. Said sub-pack holding case in claims 1, 3 and 4, when being installed in a said vehicle sub-pack compartment in claims 1 and 5, its said anode cable and said cathode cable in claims 3 and 4 further having their other ends connected with said sub-pack control panel in claims 1 and 6, and with other functional units that are not claimed herein, of an electric vehicle.

10. Said sub-pack holding case in claims 1, 3 and 4, when being installed in a said recharging sub-pack compartment in claims 1 and 7, its said anode cable and said cathode cable in claims 3 and 4 further having their other ends connected with said recharging array control panel in claims 1 and 8, and with an electricity source that is not claimed herein.

11. Said supporting cart in claim 1 further comprising
staircase-type multi supporting steps with their heights corresponding to heights of said recharging sub-pack compartments in said recharging array in claims 1, 3, 4 and 7, so that each said supporting step can support a corresponding said sub-pack holding case in claims 1, 3 and 4 when said sub-pack holding case is drawn out from said recharging sub-pack compartment in said recharging array;
four all-way wheels at bottom frame as moving means, and
a security hook at each said supporting step to secure said sub-pack holding case when being placed on said supporting step.
